(19) United States
(12) Patent Application Publication
(10) Pub. No.: US 2004/0228149 A1
(43) Pub. Date: Nov. 18, 2004

(54) Trophy structure

(76) Inventor: Liao Tsang-tse, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/435,352

(22) Filed: May 12, 2003

(51) Int. Cl. F21S 4/00

(52) U.S. Cl. 362/565

(57) ABSTRACT

The present invention discloses a trophy structure, comprising a base, a main body disposed on the base, a figure object disposed on the main body, at least one first luminous object disposed on the periphery of the main body, at least one second luminous object disposed on the main body at a position corresponsive to the figure object, and the first and second luminous objects are coupled to a control circuit by a circuit, so that users can control the first and second luminous objects through the switch to turn on/off the control circuit. The first and second luminous objects will reproduce a light circulating in circles similar to a revolving lantern, or a light similar to the twinkling star such that the figure object can be more prominent, and thus producing an outstanding effect for the whole trophy.

### BACKGROUND OF THE INVENTION

1. Field of the Invention

The present invention relates to a trophy structure having a control circuit electrically coupled to an illumination circuit and giving various changes to the illumination circuit to make the figure object more prominent under the illumination produced by the illumination circuit.

2. Description of the Related Art

The structure of a prior-art medal, cup, or a trophy usually comprises a base body, a figure object protruded from the base body and the figure object represents the content of the issued award such as baseball, football, or various ball games or track-and-field sports symbolized by the medal, cup and trophy. Light bulbs are installed around the periphery of the base body. However, the structure of such prior-art device only has a monotonic change, not only being unexciting, but also will lose audience after being shown for a long time.

In view of the shortcomings of the prior-art trophy that is monotonous and unexciting in its use and unable to prominently show the figure object, the present inventor aimed at the problem and started finding a way for its improvement and overcoming its shortcoming. The present inventor based on years of experience accumulated from the engagement in the related industry conducted extensive research to resolve the aforementioned shortcomings and invented the trophy structure of the present invention.

### SUMMARY OF THE INVENTION

The primary objective of the present invention is to provide a trophy structure comprising a base, a main body disposed on the base, a figure object disposed on the main body, at least one first luminous object disposed on the periphery of the main body, at least one second luminous object disposed on the main body at a position corresponsive to the figure object such that the second luminous object maintains a certain distance from the figure object, and the first and second luminous objects are coupled to a control circuit by a circuit, so that users can control the first and second luminous objects through the switch to turn on/off the control circuit. The first and second luminous objects will reproduce a light circulating in circles similar to a revolving lantern according to the instruction of the controller, or a light similar to the twinkling star such that the figure object can be more prominent, and thus producing an outstanding effect for the whole trophy.

A secondary objective of the present invention is to provide a trophy structure with its switch installed on the base to make its application more convenient for users.

Another objective of the present invention is to provide a trophy structure with its switch electrically connected to a video circuit, such that when the switch is turned on, the control circuit controls the video circuit to produce sound and thus further giving more changes to the trophy structure.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of the disassembled parts of the present invention.

FIG. 2 is a perspective diagram of the assembled trophy structure according to a preferred embodiment of the present invention.

FIG. 3 is a perspective diagram of the assembled trophy structure according to the present invention when it is in use.

### DETAILED DESCRIPTION OF THE PREFERRED EMBODIMENTS

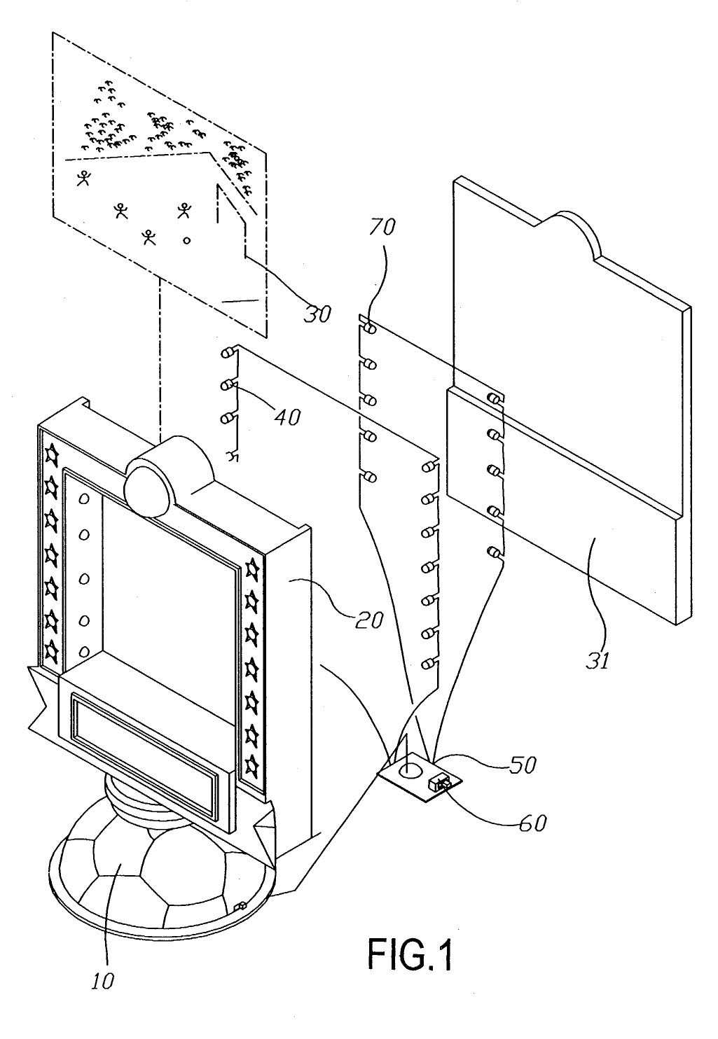

Please refer to FIG. 1 for the trophy structure of the present invention. Such structure comprises a base 10, which is a circular disc base in this embodiment, but the persons skilled in the art can substitute it with another equivalent object; a main body 20 disposed on the base 10, and the main body 20 could be in any stylish form, which is a rectangular frame in this embodiment; the main body 20 having a figure object 30, which is in a stylish form of a football field in this embodiment, however the persons skilled in the art may change it to other stylish forms; the figure object 30 at its backside having a stylish form corresponding to the rear panel 31 of the main body 20, and the rear panel 31 being exactly mounted on the backside of the main body 20 such that the figure object 30 can be fixed onto the rear panel 31 and protruded from the main body 20; a first luminous object 40 being disposed at a specific position on the figure object 30, which is a light emitting diode (LED) in this embodiment, and such first luminous object 40 may change its position according to the desired prominent position.

Furthermore, more than one luminous object 40 is disposed on the surface along the periphery of the main body 20, and such first luminous objects 40 surround the periphery of the main body 20; the first luminous object 40 is coupled to a control circuit 50 by a circuit, which is a circuit board in this embodiment; the control circuit 50 is coupled with a switch 60 by a circuit, and such switch 60 is coupled to a video circuit (not shown in the figure) on the control circuit 50; such switch 60 is mounted onto the base 10 and protruded from the surface of the base 10; at least one second luminous object 70 is disposed on the main body 20 at a position corresponding to the figure object 30, which is a light emitting diode (LED) in this embodiment, and the second luminous object 70 is installed onto the inner side of the main body 20; the second luminous object 70 is coupled to the control circuit 50 by a circuit such that the first and second luminous objects 40, 70 can produce a continuous circulating light similar to that of a revolving lantern and a light similar to a twinkling star by the control of the control circuit.

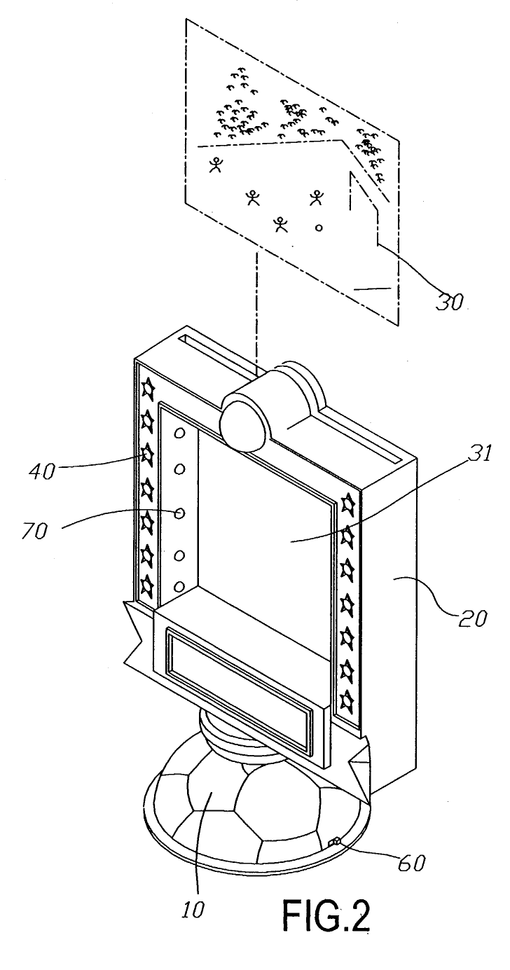

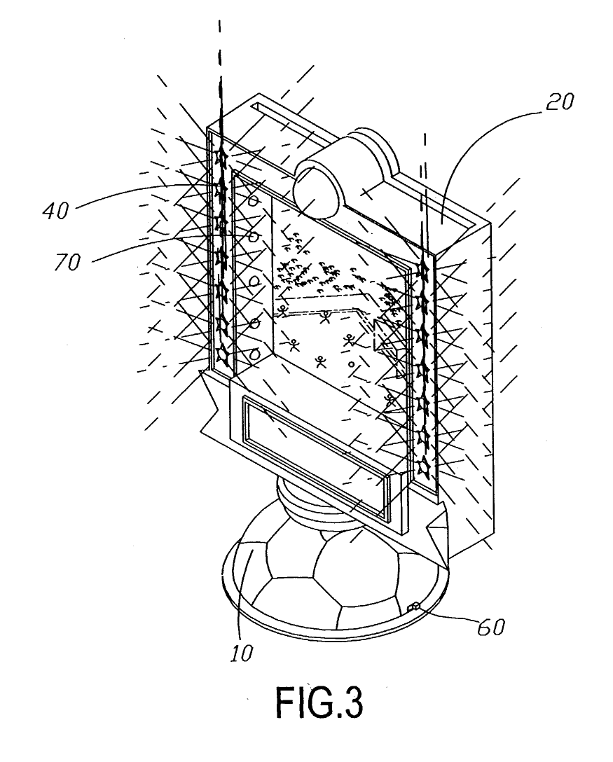

Please refer to FIGS. 1, 2, and 3 for the application of the trophy. When the user presses a switch 60 to turn on a control circuit 50, the control circuit 50 can control a video circuit, a first luminous object 40, and a second luminous object 70, wherein the first luminous object 40 follows the instruction of the control circuit to produce a continuous circulating light similar to that of revolving lantern to attract viewers' attention, and the second luminous object 70 will follow the instruction of the control circuit 50 to produce a light similar to that of a twinkling star projecting onto the figure object 30 which makes the figure object prominent, and thus producing an outstanding effect for the whole trophy. The video circuit can produce sound during or before the luminous object take actions, and thus further adding variations to the whole trophy.

In summation of the above description, the trophy structure of the present invention definitely has a simple structure and facilitates its use for a special effect, and further improves the consumer's willingness for its use. The present invention definitely overcomes the shortcomings of the prior art and enhances the performance and utility of the conventional trophy structure is submitted to the Patent and Trademark Office for review and granting of the commensurate patent rights.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

What is claimed is:

1. Atrophy structure, comprising:
a base;
a main body, disposed on said base;
a figure object, mounted on said main body;
at least one first luminous object, disposed on the periphery of said figure object and main body;
at least one second luminous object, disposed on the main body at a position corresponding to the figure object;
a control circuit, coupled to said first and second luminous objects respectively by a circuit, and having an ON/OFF switch; and
by means of the assembling of the foregoing components, said control circuit being turned on and off by users to control said first and second luminous objects;
wherein said first luminous object producing a light unceasingly circulate like a revolving lantern according to instructions to attract viewer's attention , and said luminous object emitting a light similar to a twinkling star and projecting the light on said figure object to make said figure object prominent.

2. The trophy structure of claim 1, wherein said control circuit is in said base.

3. The trophy structure of claim 1, wherein said ON/OFF switch is installed on the surface of said base.

4. The trophy structure of claim 1, wherein said first luminous object is a light emitting diode (LED).

5. The trophy structure of claim 1, wherein said second luminous object is a light emitting diode (LED).

6. The trophy structure of claim 1, wherein said control circuit is a circuit board.

7. The trophy structure of claim 1, wherein said switch circuit is electrically coupled to a video circuit.
